(19) United States
(12) Patent Application Publication
(10) Pub. No.: US 2011/0073711 A1
(43) Pub. Date: Mar. 31, 2011

(54) JOINING OF STRUCTURAL AIRCRAFT ELEMENTS

(75) Inventors: José Maria Pina López, Madrid (ES); Enrique Vera Villares, Madrid (ES)

(73) Assignee: AIRBUS OPERATIONS, S.L., Madrid (ES)

(21) Appl. No.: 12/629,805

(22) Filed: Dec. 2, 2009

(30) Foreign Application Priority Data
Sep. 30, 2009 (ES) 200930772

(51) Int. Cl. B64C 1/06

(52) U.S. Cl. 244/131

(57) ABSTRACT

Joining of a structural aircraft element (1) that has a section in an omega shape, to another structural aircraft element (10) with a differently shaped section, with the aforementioned joint of these structural elements (1, 10) with a different section comprising at least two joining elements (4) in an angular shape, which are joined with the external flanges (5) of the structural elements (1, 10), in such a manner that this joint allows the section change to take place continually, through simple elements (4) in its manufacturing and assembly, thanks to its geometric simplicity. The assembly of this joining of structural elements (1, 10) is also with a section change of great flexibility, allowing the tolerances of the joint to be absorbed, and achieving that the load distribution between the structural elements (1, 10) and the joining elements (4) is optimal.

### FIELD OF THE INVENTION

This invention refers to the joining of structural aircraft elements, in particular to the joining of a structural element with a section in an omega shape to another structural element with a section in a different shape.

### BACKGROUND OF THE INVENTION

The fuselage is the main component of an aircraft, given that the remaining elements that make up the aircraft are directly or indirectly joined to it. The skin of the fuselage is what gives it its shape, which varies with the main mission that the aircraft will have.

In addition to the skin, the fuselage of an aircraft comprises metal or composite material structural elements, which mainly consist of stringers and frames, which are responsible for giving shape and rigidity to the fuselage structure upon which they are arranged.

The frames, responsible for giving shape and rigidity to the fuselage structure, are structural elements in the shape of perpendicular reinforcements with respect to the lengthwise axis of the aircraft, which are located at intervals on the inside of the fuselage tube of the aircraft. In addition to the frames, the fuselage comprises other structural reinforcement elements, the stringers, in order to achieve optimization of distribution of loads and rigidity. The stringers are located on the skin according to the lengthwise direction of the fuselage, with their presence allowing the reduction of the skin of the fuselage structure, thus lightening the weight of the combined structure. In addition, there are other structural elements in the aircraft, named beams, which work under flexion and torsion, in certain areas of the aircraft, i.e. load introducing areas, openings in the fuselage (i.e. maintenance doors).

Today, the use of composite materials is increasingly more frequent in aeronautical structures, in such a way that the weight of the aforementioned structures is lightened, which positively impacts in the overall weight of the aircraft. Thus, the aforementioned structural elements, stringers and frames, are mainly embodied in composite material. In this manner, the stringers are designed more frequently in omega section, which achieves the separating of the part of the structure that most contributes to the calculation of the moment of inertia of said structure from the centre of gravity. This therefore achieves a more rigid stringer.

In some areas of the internal structure of the aircraft fuselage, openings or holes appear that are necessary for the passage or placement of other aircraft elements, maintenance, etc. Around these areas, when the fuselage structure has been weakened, and the local rigidity has decreased to a great extent, it is necessary for the structural elements, stringers or beams to have greater rigidity in said areas, for which stringers or beams tend to be used to increase the rigidity of the aforementioned areas, with the local structural rigidity of the same thus increasing. This causes these stringers or beams to quite frequently have a T or I section, typically.

Until now, and according to the known art, with the stringers being built mainly in a T section, joining this T stringer to a beam or T or I stringer did not pose difficulties, with the two webs from both elements being in many occasions coplanar.

However, and as has been explained before, the problem is posed when the joining of a stringer is attempted with an omega-shaped section and another structural element, whether this be another stringer, or a beam, with a different section, typically a T or I section.

As per the first known approximation, this problem is resolved through the use of joining parts that give continuity to said sections, element by element. These solutions entail the problem that the joint parts to be used normally have very complex geometry, and therefore they are very difficult to manufacture, being also extremely difficult to join or assemble, since it is necessary on many occasions to use supplements for joining multiple support faces. In addition, on occasions it is not possible to use these supplements due to assembly limitations, with the gaps to cover being greater than the limits for the possibility of applying a liquid sealant (typically, around 0.5 mm).

This invention offers a solution to the aforementioned problems.

### SUMMARY OF THE INVENTION

Thus, this invention refers to the joining of structural aircraft elements, with said elements being made of composite material or metal, specifically to the joining of a structural element with a section in an omega shape, to another structural element with a differently shaped section, typically in a T or I shape. The joining of these structural elements with a different section comprises at least two joining elements in an angular shape, which are joined with the external flanges of the structural elements, in such a manner that this joint allows the section change to take place continually, through simple elements in its manufacturing and assembly, thanks to its geometric simplicity.

The angular shaped joint parts have sections in an L, C or J shape, preferably.

Some of the advantages that are brought forward by this joint of structural elements are the following:
Since the angular-shaped joining elements are simple, several manufacturing methods can be adopted for the same (sheet metal bended, metal machining, composite material);
The assembly of this joint for structural elements with a section change is highly flexible, allowing the tolerances of the joint to be absorbed (assembly, positioning, manufacturing).
The distribution of loads among the structural elements and the joining elements is optimal.

Other characteristics and advantages of this invention will be taken from the detailed description that follows of an embodiment illustrating its purpose in relation to the attached figures.

### DESCRIPTION OF THE FIGURES

FIG. 1 shows a schematic of the joint for structural elements with a section change, as per the known art.

FIGS. 2a and 2b show several views of the joint for structural elements as per the invention, in which one structural element has an omega section and another has an I section.

FIG. 3 shows the joint for structural elements in a schematic as per the invention, in which one structural element has an omega section and another has a T section.

### DETAILED DESCRIPTION OF THE INVENTION

In aeronautic structures, the use of structural elements is becoming more and more widespread, specifically stringers 1, with a section that is typically omega, due to the great rigidity and low weight offered by structures of this kind, being embodied today in composite material in the majority of the cases, although these elements can also be manufactured in metal.

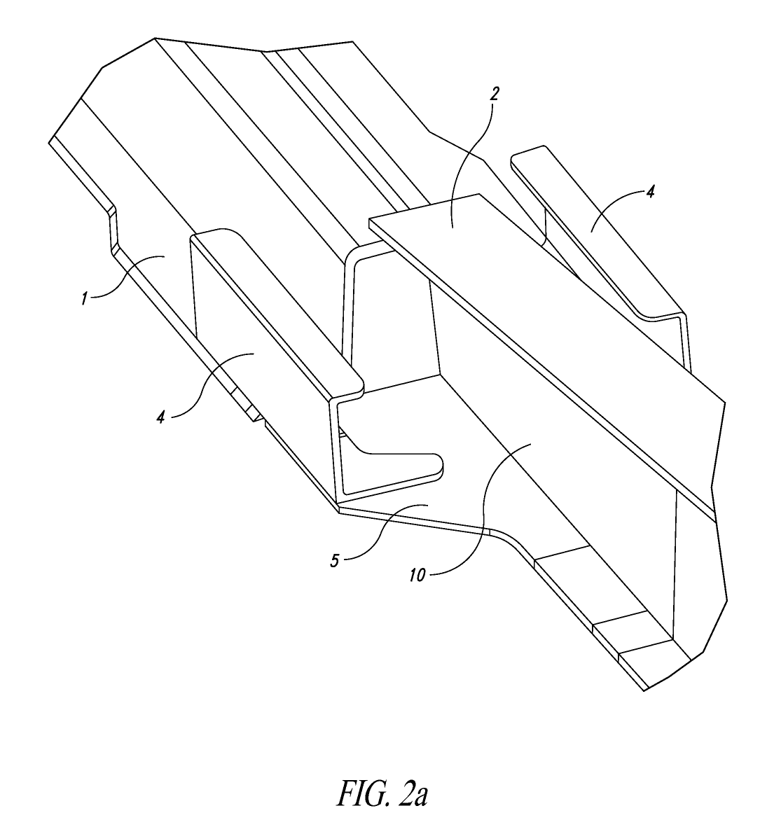

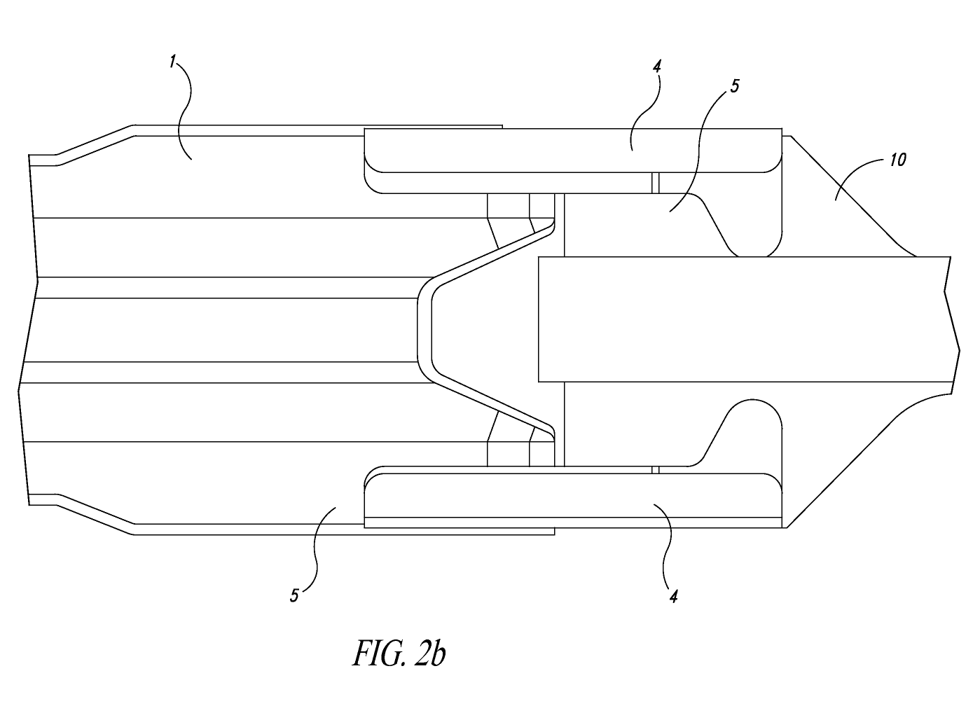

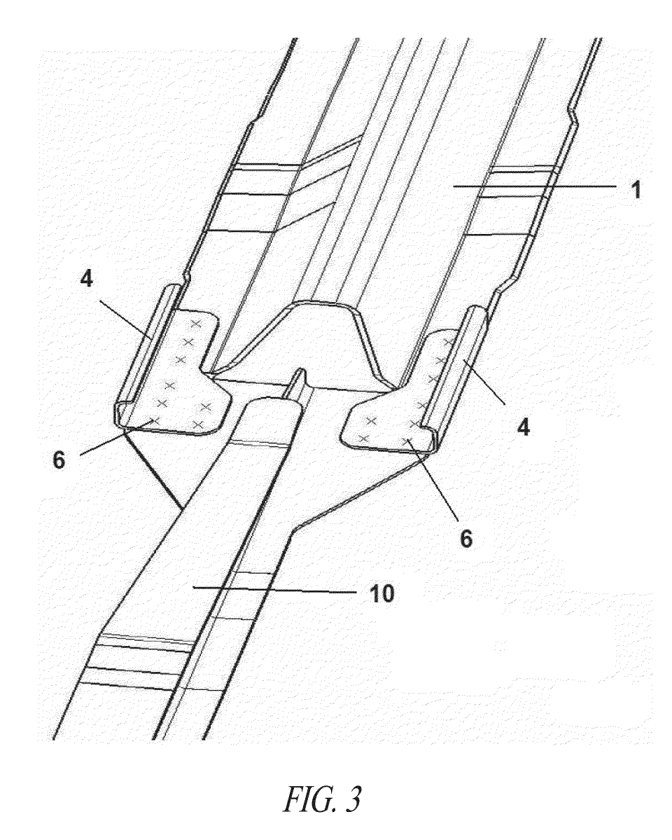

In many occasions, it is necessary to give continuity to the joint of a structural aircraft element (particularly a stringer 1) with another structural element 10, whether this be a beam or a stringer, which has a different section (i.e. a stringer 1 with an omega section that is joined to a beam or stringer 10 with an I section, FIGS. 2a, 2b or with a T section, FIG. 3).

Thus, this invention refers to the joining of structural aircraft elements, specifically structural aircraft elements embodied in composite material, such that one of these elements, specifically a stringer 1, has an omega-shaped section, with the other structural element, a stringer or beam 10, having a different section, typically in a T or I shape. Normally, these section changes occur around an area that needs to be reinforced, such as an opening, in local load introduction areas, etc. The joint as per the invention of elements 1 and 10 comprises at least two joining elements 4 in an angular shape that are joined with the external flanges 5 of the structural elements (FIGS. 2a and 2b), in such a manner that this joint allows the section change to take place continually.

The joint parts 4 in an angular shape have sections in an L, C or J shape, preferably. In addition and also in a preferred embodiment, these parts 4 are fastened through rivets 6 on external flanges 5 of the structural elements 1 and 10 in question, to which we are attempting to give continuity.

The joint 4 parts can be made of composite or metal material, depending on the load requirements to be transferred, and the material of the structural elements 1 and 10, among others.

Some of the advantages that are shown by the joining of these structural elements as per the invention are the following:
Since the joint 4 elements are simple and in an angular shape, several methods may be adopted for manufacturing the same: laminated or RTM (Resin Transfer Moulding) of CFRP (Carbon Fibre Reinforced Polymer), if the structural elements are of composite material, and bent or machined out of metal, in the case where the structural elements are metal;
The assembly of the joint for structural elements 1 and 10, in which the section change is performed as indicated above, is one of great flexibility, allowing the tolerances of the joint (assembly, positioning, manufacturing) to be absorbed;
The distribution of loads between the structural elements 1 and 10 and the joint 4 elements is optimal.

The effective transfer of the loads through the joint, is achieved by decreasing the effective area of the web and inner flanges of the structural elements 1 and 10, then loads (shear, traction or compression) are directed to the external flanges 5 of the joint for the structural elements 1 and 10 to the aircraft covering, with the aforementioned loads passing through the skin by way of rivets 6 preferably, at the same time as the joining elements 4 support and provide continuity to the flexion and torsion loads. There is also the possibility that the joining of the joint 4 elements to the external flanges 5 of the structural elements 1 and 10 could be done through an adhesive.

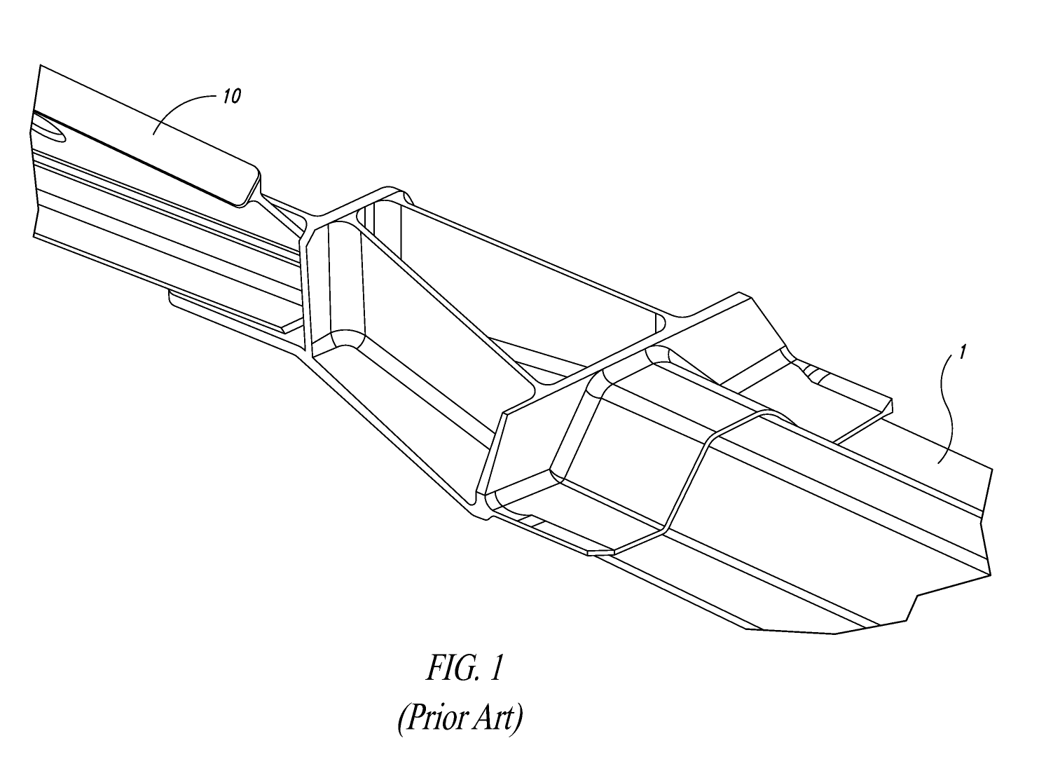

Other known solutions attempt to provide element to element continuity (web-web, flanges-flanges), which on most occasions involves parts with very complex geometry, that are difficult to manufacture and assemble, with multiple support faces that can lead to the use of assembly supplements. In many occasions the use of these supplements is not possible (see FIG. 1).

The joining elements 4 in an angular shape are arranged in such a way that they are substantially aligned with the main reference planes of the structural elements 1 and 10.

In the preferred embodiments that we have just described, those modifications can be introduced that are within the scope defined by the following claims.

1. Joint of a structural aircraft element (1) that has a section in an omega shape, to another structural aircraft element (10) with a differently shaped section, characterized in that the aforementioned joining of these structural elements (1, 10) with a different section comprises at least two joining elements (4) in an angular shape, which are joined with the external flange (5) of the structural elements (1, 10), in such a manner that this joint allows the section change to take place continually, through simple elements (4) in its manufacturing and assembly, thanks to its geometric simplicity. The assembly of this joining of structural elements (1, 10) is also with a section change of great flexibility, allowing the tolerances of the joint to be absorbed, and achieving that the load distribution between the structural elements (1, 10) and the joining elements (4) is optimal.

2. Joining of a structural aircraft element (1) as per claim 1, in which the aforementioned element (1) with a section in an omega shape is a stringer (1).

3. Joining of a structural aircraft element (1) as per any of the above claims, in which the structural element (10) is a beam or stringer of the aircraft.

4. Joining of a structural aircraft element (1) as per any of the above claims, in which the structural element (10) has a section in an I or T shape.

5. Joining of a structural aircraft element (1) as per any of the above claims, in which the joining elements (4) in an angular shape have sections in an L, C or J shape.

6. Joining of a structural aircraft element (1) as per any of the above claims, in which the joining elements (4) in an angular shape are fastened through rivets (6) on the external flanges (5) of the elements (1, 10).

7. Joining of a structural aircraft element (1) as per any of the claims 1 to 5, in which the joining elements (4) in an angular shape are bonded to the external flanges (5) of the elements (1, 10).

8. Joining of a structural aircraft element (1) as per any of the above claims, with the element (1) that has a section in an omega shape and the element (10) with a different section being of composite material.

9. Joining of a structural aircraft element (1) as per any of the claims 1 to 7, with the element (1) that has a section in an omega shape and the element (10) with a different section being made of metal.

10. Joining of a structural aircraft element (1) as per claim 8, in which the joining elements (4) in an angular shape are manufactured through laminate or RTM of CFRP.

11. Joining of a structural aircraft element (1) as per claim 9, in which the joining elements (4) in an angular shape are manufactured through bending or machining of metal.
